(19) United States
(12) Patent Application Publication
(10) Pub. No.: US 2001/0025420 A1
(43) Pub. Date: Oct. 4, 2001

(54) Working tool for manufacturing bearing member, manufacturing apparatus incorporating the same and manufacturing method using the same

(76) Inventor: Motonori Usui, Nagano (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/822,514

(22) Filed: Apr. 2, 2001

(30) Foreign Application Priority Data
Mar. 31, 2000 (JP) P.2000-096391

(51) Int. Cl. B23P 19/04; B21D 53/10

(52) U.S. Cl. 29/898; 29/724

(57) ABSTRACT

When inserting a finishing tool 41 into a bearing hole 13A3, firstly, by inserting an insertion guide portion 41c formed on the leading end side of the finishing tool 41 into the bearing hole 13A3, the finishing tool 41 is inserted into the bearing hole 13A3 in such a manner that the angle and parallelism of the axis of a pressure contact working portion 41b, which is situated on the rear side of the finishing tool 41 and continues with the insertion guide portion 41c, can be gradually aligned with the axis of the bearing hole through a floating holder mechanism 42. In a state where the axis of the pressure contact working portion 41b is automatically aligned with the axis of the bearing hole with high precision, the working of the bearing hole using the pressure contact working portion 41b is started. After then, due to the pressure-contact plastic deformation of the bearing hole by the pressure contact working portion 41b, the inner peripheral surface of the bearing hole of the bearing member is finish worked with high precision.

### BACKGROUND OF THE INVENTION

The present invention relates to an apparatus for manufacturing a bearing member, a method for finish working an inner peripheral surface of a bearing hole of the bearing member using a proper finishing tool, and a working tool for use in such apparatus and method. Particularly, the present invention is suitable for manufacture of a bearing used in a dynamic pressure bearing apparatus requiring high precision.

Generally, in various rotary drive apparatus, there are used various bearing members such as a metal bearing, a sintered bearing and a dynamic pressure bearing. In manufacturing these bearing members, the inner surface of a bearing hole formed therein is worked. And, in such working, normally, there is employed a cut working (lathing) in which the hole diameter of a provisional hole is firstly enlarged by a rough cut working and, after then, it is finish worked so that the inner peripheral surface of the bearing hole can have desired inside diameter, surface roughness and roundness.

However, in the finish working of the bearing inner peripheral surface according to the above cut working (lathing), there are left cut traces and wavy traces after the finish working and, therefore, the bearing inner peripheral surface can be finished with such precision that the inside diameter tolerance is ±2 μm or less, the surface roughness thereof is 0.2 RA or less and the roundness is 0.5 μm or less.

Especially, for the dynamic pressure bearing apparatus, in case where the bearing inner peripheral surface is going to be finish worked with higher precision than the above precision, not only the working time increases remarkably but also there arises the need for use of an expensive high precision automatic lathe apparatus, resulting in the extremely lowered bearing productivity. Also, for these working reasons, there are present substantial limitative points on the bearing characteristics of the bearing member, which makes it very difficult to obtain a high-performance bearing member at a low cost.

### SUMMARY OF THE INVENTION

In view of the above, it is an object of the invention to provide bearing member manufacturing apparatus and method as well as a working tool for use in such apparatus and method, which are capable of finish working the inner peripheral surface of a bearing hole in a bearing member with high precision and at a low cost.

In order to achieve the above object, according to the invention, there is provided an apparatus for manufacturing a bearing member formed with a bearing hole, comprising:

a finishing tool, that finishes an inner peripheral surface of the bearing hole, the finishing tool including:

a pressure contact working portion, inserted into the bearing hole to plastically deform the inner peripheral surface by applying a press contact force thereon; and

an insertion guide portion, provided in a front side of the pressure contact working portion with respect to the bearing hole; and

a floating mechanism, that holds the finishing tool movably in a radial direction of the bearing hole and slantably with respect to an axis of the bearing hole.

According to the manufacturing method using the manufacturing apparatus, when inserting the finishing tool into the bearing hole, firstly, the insertion guide portion formed on the leading end side of the finishing tool is inserted into the bearing hole; as the insertion of the insertion guide portion advances, the angle and parallelism of the axis of a pressure contact working portion, which is situated on the rear side of the finishing tool and continues with the insertion guide portion, can be gradually aligned with the axis of the bearing hole through use of the floating mechanism. At the time when the pressure contact working portion is inserted into the bearing hole, the axis of the pressure contact working portion can be automatically aligned with the axis of the bearing hole with high precision. And, in such high-precision alignment state, the working of the bearing hole by the pressure contact working portion is started. After then, due to the pressure-contact plastic deformation of the bearing hole by the pressure contact working portion, the inner peripheral surface of the bearing hole of the bearing member can be finished with high precision without leaving therein any cut traces or wavy traces that could occur in the conventionally used cut working.

Preferably, the insertion guide portion includes: a front end guide portion provided in a leading end of the finishing tool and having a diameter which is smaller than a diameter of the press contact working portion; and a tapered portion for continuously connecting the front end guide portion and the press contact working portion.

In this configuration, the guide operation to align the axis of the pressure contact working portion with the axis of the bearing hole can be carried out smoothly without causing any damage to the bearing member.

Preferably, a sizing working tool serves as the press contact working portion. In this configuration, the finish working of the bearing inner peripheral surface can be executed with very high precision.

Here, the sizing working tool is provided with a predetermined lead angle in accordance with a hardness of the bearing member to be worked. The lead angle is increased as the material of the bearing member increases in hardness.

In this configuration, even in the case of hard material such as stainless steel, the inner peripheral surface of the bearing member can be finish worked with desired high precision.

The invention is especially effective in finish working a dynamic pressure bearing member the finished inner surface of which requires high precision and includes a dynamic pressure generating groove formed in the inner peripheral surface of a bearing hole thereof.

A dynamic pressure groove may be formed on the inner peripheral surface of the bearing hole, before inserting the insertion guide portion of the finishing tool.

To do this, a raised portion to be unnecessarily formed in the formation of the dynamic pressure generating groove can be removed by the finish working, with the result that the step of removing the raised portion can be omitted.

### BRIEF DESCRIPTION OF THE DRAWINGS

In the accompanying drawings:

FIG. 1 is a side view of a sizing working tool according to one embodiment of the invention;

FIG. 2 is a longitudinal section view of a motor for an HDD (hard disk drive) including a dynamic pressure bearing member;

FIG. 3 is a longitudinal section view of the bearing member used in the apparatus shown in FIG. 2;

FIG. 4 is a side view of an example of a manufacturing apparatus for the bearing member, which incorporates the sizing working tool shown in FIG. 1;

FIGS. 5A to 5E are explanatory views showing working steps to be executed by the manufacturing apparatus shown in FIG. 4;

FIG. 6 is a side view of a sizing working tool according to another embodiment of the invention;

FIG. 7 is a transverse section view of one example of the sizing working tool;

FIG. 8 is a transverse section view of another example of the sizing working tool;

FIG. 9 is an enlarged view of the surface of a bearing work, showing the state thereof before it is finish worked by the sizing working tool;

FIG. 10 is an enlarged view of the surface of the bearing work, showing the state thereof after it is finish worked by the sizing working tool;

FIG. 11 is an enlarged side view of the surface of the bearing work, showing the state thereof before it is finish worked by the sizing working tool, in a case where the working steps shown in FIG. 5D is omitted;

FIG. 12 is an enlarged front view of the surface of the bearing work, showing the state thereof before it is finish worked by the sizing working tool, in a case where the working steps shown in FIG. 5D is omitted;

FIG. 13 is an enlarged side view of the surface of the bearing work, showing the state thereof after it is finish worked by the sizing working tool, in a case where the working steps shown in FIG. 5D is omitted;

FIG. 14 is an enlarged front view of the surface of the bearing work, showing the state thereof after it is finish worked by a sizing working tool in a case where the working steps shown in FIG. 5D is omitted; and

FIG. 15 is a graphical representation of the influences on the roundness and surface roughness of the bearing work when the sizing working tool is set in a deviant manner.

### DETAILED DESCRIPTION OF THE PREFERRED EMBODIMENTS

Now, prior to description of the preferred embodiment the invention, description will be given below of the whole structure of a hard disk drive (HDD) to which the invention is applied with reference to the accompanying drawings.

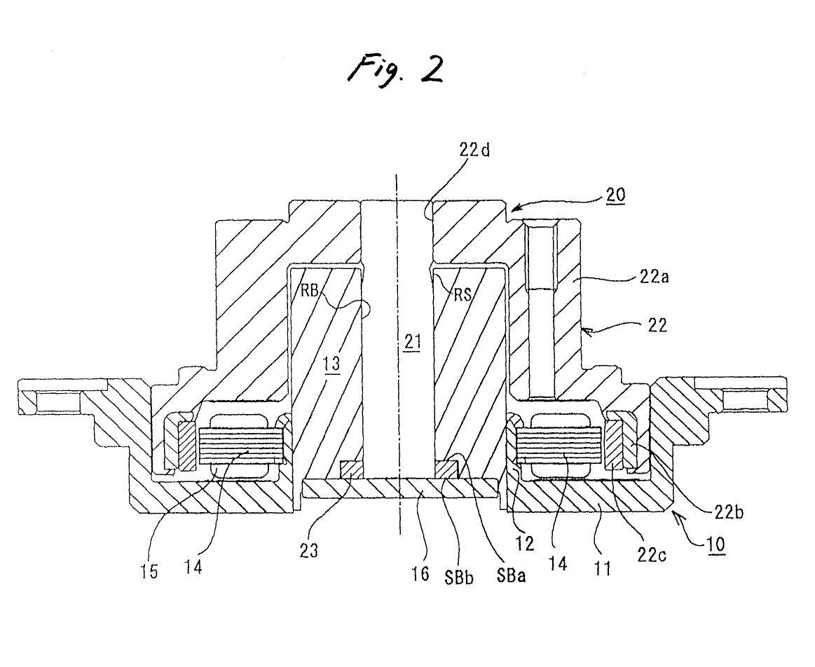

The whole structure of a spindle motor for HDD of a shaft rotation type shown in FIG. 2 is composed of a stator assembly 10 serving as a fixed part and a rotor assembly 20 serving as a rotary part which is assembled to the stator assembly 10 from the upper side in FIG. 2. The stator assembly 10 includes a fixing frame 11 which is to be screwed to the fixing base member (not shown) side. This fixing frame 11 is made of aluminum-family metal material for the purpose of reduction of the weight thereof and, substantially on the central portion of the fixing frame 11, there is erected an annular-shaped bearing holder 12; and, on the inner peripheral side of the bearing holder 12, a bearing sleeve 13 serving as a fixed bearing member formed in a hollow cylindrical shape is connected to the bearing holder 12 by pressure insertion or by shrink-fitting. This bearing sleeve 13 is made of copper-family alloy material such as bronze phosphate in order to be able to facilitate the working of a small-diameter hole.

Also, a stator core 14, which consists of a laminated body of electromagnetic steel plates, is fitted with and mounted on the outer peripheral face of the bearing holder 12. The stator core 14 includes two salient poles with their associated drive coils 15 wound therearound respectively.

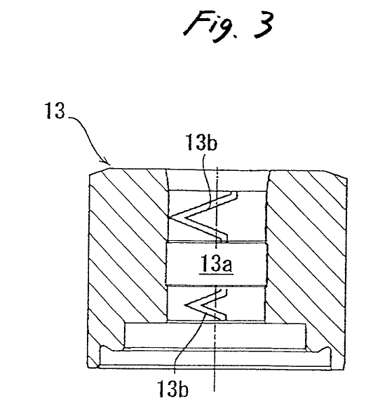

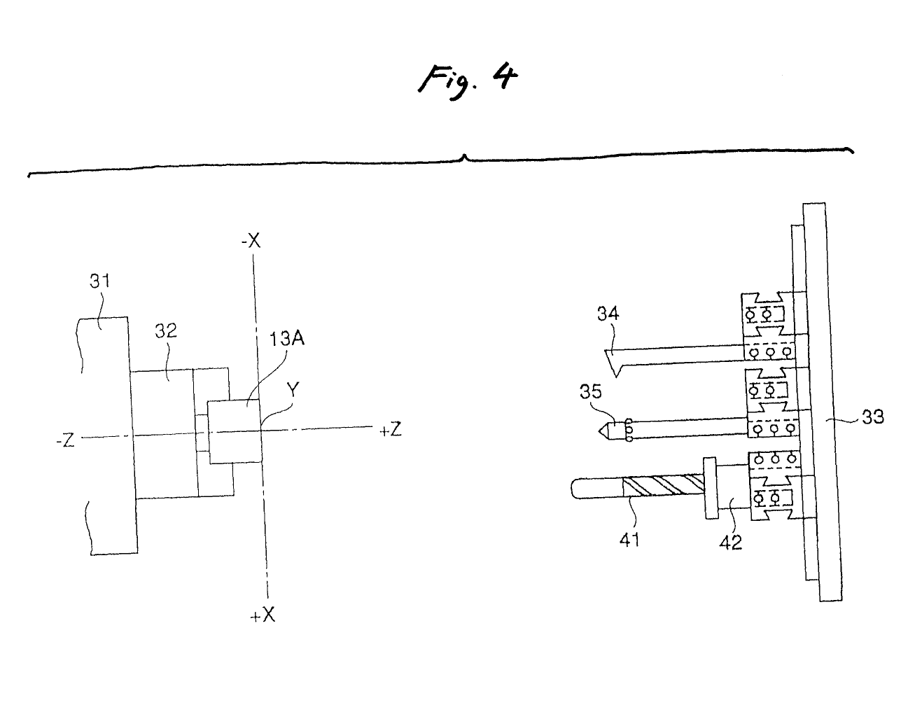

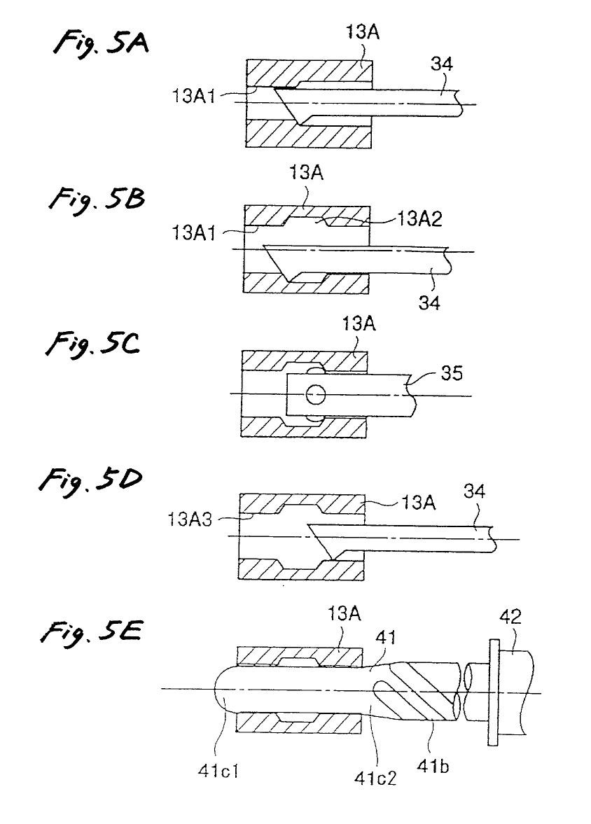

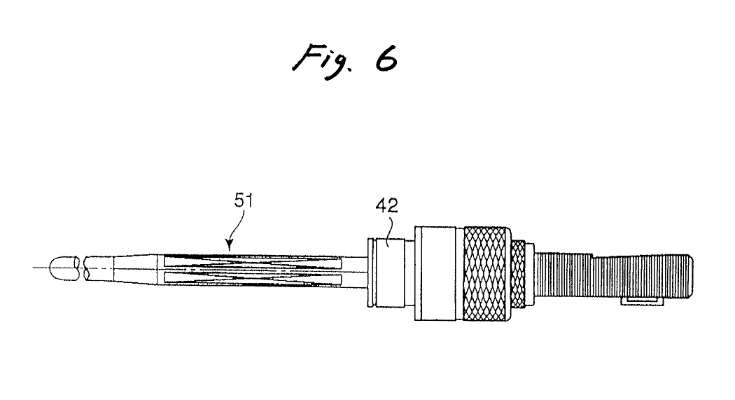

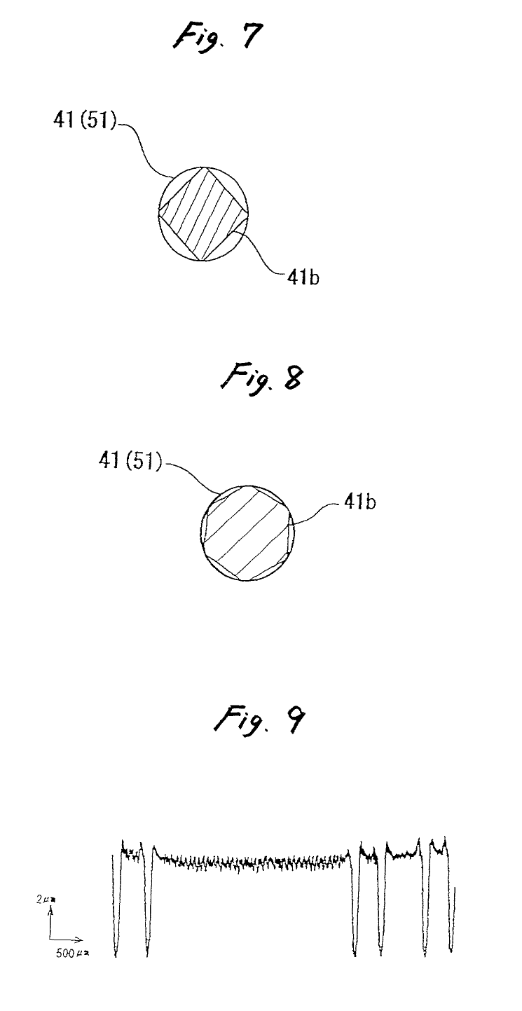

Further, as shown in FIG. 3 as well, into a bearing hole 13a formed in the center position of the bearing sleeve 13, there is inserted a rotary shaft 21 which forms part of the rotor assembly 20. The rotary shaft 21 according to the present embodiment is made of a given type of stainless steel and the bearing sleeve 13 serving as the above-mentioned bearing member is made of material more flexible than the rotary shaft 21 serving as the shaft member.

A dynamic pressure face, which is formed on the inner peripheral face of the bearing hole 13a of the bearing sleeve 13, is disposed such that it is opposed in the radial direction to a dynamic pressure face formed on the outer peripheral face of the rotary shaft 21; and, in the minute bearing clearance portion of the dynamic pressure face of the bearing sleeve 13, there is formed a radial dynamic pressure bearing portion RB. The dynamic pressure face of the radial dynamic pressure bearing portion RB on the bearing sleeve 13 side is disposed so as to be circumferentially opposed to the dynamic pressure face on the rotary shaft 21 side with a slight clearance of several μm between them; and, a lubricating fluid is poured into a bearing space defined by such slight clearance in such a manner that it continues in the axial direction of the rotary shaft 21.

At least on one side of the two dynamic pressure faces of the bearing sleeve 13 and rotary shaft 21, for example, there are annularly recessed formed herringbone-shaped radial dynamic pressure generating grooves 13b in such a manner that they are divided into two blocks in the axial direction; and, in rotation, the lubricating fluid is pressed due to the pumping action of the radial dynamic pressure generating grooves 13b to thereby generate dynamic pressures, so that the rotary shaft 21 and rotary hub 22 are supported in the radial direction.

On the upper end portion of the bearing space forming the radial dynamic pressure bearing portion RB, there is disposed a capillary seal portion RS. This capillary seal portion RS is structured such that the bearing clearance is gradually spread toward the outside of the bearing by an inclined surface formed on the rotary shaft 21 side or on the sleeve 13 side; and, the capillary seal portion RS is so set as to have a clearance dimension, for example, in the range of 20 μm to 300 μm. Also, the capillary seal portion RS is structured such that, in either case where the motor is rotated or stopped, the liquid surface of the lubricating fluid is flush with the capillary seal portion RS.

The rotary hub 22, which cooperates with the rotary shaft 21 in forming the rotor assembly 20, is composed of a substantially cup-shaped member made of aluminum-family metal in such a manner that it is capable of carrying thereon a recording medium such as a magnetic disk; and, a connecting hole 22d, which is formed in the central portion of the rotary hub 22, is connected to the upper end portion of the rotary shaft 21 by pressure insertion or by shrink-fitting.

The rotary hub 22 includes a substantially cylindrical-shaped body portion 22a for carrying a recording medium disk thereon; and, on the lower side of the inner peripheral face of the body portion 22a, there is mounted an annular-shaped drive magnet 22c through a back yoke 22b. This magnet 22c is disposed in such a manner that it is close to the outer periphery side end face of the stator core 14.

To the lower leading end portion of the rotary shaft 21, there is fixed a disk-shaped thrust plate 23. This thrust plate 23 is stored in a cylindrical-shaped cavity portion recessed formed in the central portion of the lower end of the bearing sleeve 13; and, within the cavity portion of the bearing sleeve 13, a dynamic pressure face formed on the upper surface of the thrust plate 23 is disposed opposed to the dynamic pressure face formed on the bearing sleeve 13 in such a manner that the former is close to the latter in the axial direction. At least on one side of these two mutually opposed dynamic pressure faces, there is formed a dynamic pressure generating groove and thus, due to the mutually opposed clearance portions of the two dynamic pressure faces of the thrust plate 23 and bearing sleeve 13, there is formed an upper side thrust dynamic pressure bearing portion SBa.

A counter plate 16, which is composed of a disk-shaped member having a relatively large diameter, is disposed in such a manner that it is close to the lower side dynamic pressure face of the thrust plate 23. This counter plate 16 is fixedly secured so that it closes the lower end opening of the bearing sleeve 13. In the mutually closely situated and opposed clearance portions of a dynamic pressure face formed on the upper surface of the counter plate 16 and the lower side dynamic pressure face of the thrust plate 23, similarly to the above, there is formed a dynamic pressure generating groove, whereby there is formed a lower side thrust dynamic pressure bearing portion SBb.

The two dynamic pressure faces on the thrust plate 23 side forming a set of thrust dynamic pressure bearing portions SBa and SBb so disposed as to adjoin each other in the axial direction are disposed opposed in the axial direction to the two dynamic pressure faces on the bearing sleeve 13 and counter plate 16 side with a minute clearance of several μm between them; and, into a bearing space defined by such minute clearance, there is poured a lubricating liquid through the outer periphery side passage of the thrust plate 23 in such a manner that it flows continuously in the axial direction of the rotary shaft 21.

At least on one side of the dynamic pressure face of the thrust plate 23 and the dynamic pressure face of the bearing sleeve 13 and counter plate 16, there is recessed formed a known herringbone-shaped thrust dynamic pressure generating groove (not shown); and thus, in rotation, the lubricating fluid is pressurized due to the pumping action of this thrust dynamic pressure generating groove to thereby generate a dynamic pressure, so that the rotary shaft 21 and rotary hub 22 can be supported in the thrust direction.

The bearing hole 13a of the bearing sleeve 13 used as a bearing member in the above-mentioned motor is worked using such a manufacturing and working apparatus as shown in FIG. 4. That is, a bearing blank material (work) 13A for the bearing sleeve 13 is gripped by a chuck 32 which is disposed in one end of a rotary spindle 31 and, at the same time, on a tool stage (tool mounting member) 33 disposed such that it is opposed to the bearing work 13A, there are mounted a cut working (lathing) tool 34, a ball rolling tool 35, and an inner surface finishing tool 41.

The tool stage 33 is structured in such a manner that it can be reciprocated in the axial direction (Z direction) of the bearing work 13A as well as in the X and Y directions respectively perpendicular to the Z direction. And, due to the reciprocating motion of the tool stage 33 in the respective directions X, Y and Z, while selecting one of the respective tools 34, 35 and 41, on the bearing work 13A, there are enforced such a cut working (lathing) step as shown in FIGS. 5A-5D as well as such a finishing step as shown in FIG. 5E.

Firstly, on the bearing work 13A of the bearing sleeve 13 with a provisional hole 13A1 opened up therein, there is enforced a first rough working step shown in FIG. 5A; that is, using the cutting tool 34, the hole diameter of the provisional hole 13A1 is enlarged. Next, in a second rough working step including an oil groove working shown in FIG. 5B, using the same cutting tool 34, while working an oil groove 13A2 between two radial bearings, the hole diameter of the provisional hole 13A1 is enlarged further. Then, in a groove working step shown in FIG. 5C, the cutting tool 34 is replaced with the ball rolling tool 35 and the radial dynamic pressure generating groove 13b is worked. After then, in a raised portion removing step shown in FIG. 5D, raised portions, which have been unnecessarily produced in the bearing hole 13A3 in the above-mentioned working of the radial dynamic pressure generating groove 13b, are cut and removed. By the way, in case where the bearing member to be worked is not the dynamic pressure bearing member having the radial dynamic pressure generating groove 13b but is a simple slide bearing, the groove working step shown in FIG. 5C and the raised portion removing step shown in FIG. 5D are omitted.

Next, in a finish working step shown in FIG. 5E which is the characteristic portion of the invention, the bearing hole 13A3 of the bearing work 13A is worked so that it has final and finishing precision. This finish working step is carried out by switching the ball rolling tool 35 over to the finishing tool 41 according to the invention. Therefore, firstly, description will be given below of one embodiment of the finishing tool 41 according to the invention.

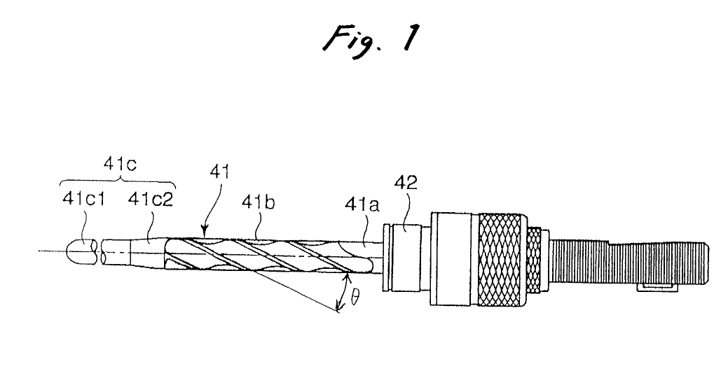

The finishing tool 41, as shown in FIG. 1, is mounted on the tool stage 33 (see FIG. 4) through a floating holder mechanism 42. The finishing tool 41 not only has a float function to provide the finishing tool 41 freedom but also holds the finishing tool 41 in such a manner that the finishing tool 41 can be moved in the radial direction (X-Y direction) with respect to the axial direction (Z direction) of the bearing work 13A as well as in the inclined angle direction inclined with respect to the axial direction (Z direction). The thus structured floating holder mechanism 42 is well known and widely used: For example, in Japanese Patent Publication No. 6-39608A, there is disclosed a floating holder mechanism which is formed integrally with a finishing tool; and, in Japanese Patent Publication No. 10-249664A, there is disclosed a floating holder mechanism which is formed separately from a finishing tool. Therefore, description of the detailed structure of the floating holder mechanism 42 is omitted here. The finishing tool 41 according to the invention may use a floating holder mechanism formed integrally with a finishing tool, or may use a floating holder mechanism formed separately from a finishing tool.

The finishing tool 41 shown in FIG. 1 uses a floating holder mechanism formed integrally with the finishing tool 41, and it includes a base end portion 41a to be chucked by the floating holder mechanism 42 and a sizing working portion (pressure contact working portion) 41b which is formed integrally with and projected from the base end portion 41a. This sizing working portion (pressure contact working portion) 41b has an outside diameter dimension which allows it to be inserted into the provisional hole 13A3 of the bearing work 13A and, in case where the sizing working portion 41b is pressed against the inner peripheral surface of the provisional hole 13A3, it deforms the provisional hole 13A3 plastically to thereby finish the same with a desired level of precision.

While the sizing working portion 41b itself is well known and widely used, for example, it has such a square-shaped section as shown in FIG. 7 or such a hexagonal-shaped section as shown in FIG. 8 and extends in the axial direction of the finishing tool 41. And, the lead angle θ (see FIG. 1) of the sizing working portion 41b where the sizing working portion 41b extends in the axial direction thereof is set such that it can be increased as the material of the bearing work 13A increases in hardness. For example, in case where the bearing work 13A is formed of soft material such as aluminum material or brass, as in a finishing tool 51 shown in FIG. 6, the lead angle θ is set at 0°. But, on the other hand, in case where the bearing work 13A is formed of hard material such as normal iron material or stainless steel, as shown in FIG. 1, the lead angle θ is set in the range of 30°-40°; that is, by use of the sizing working portion 41b having such large lead angle θ, even the hard material can be worked properly.

On the forward side of the insertion direction (in FIG. 1, left direction) of the sizing working portion 41b, there is provided an insertion guide portion 41c serving as a guide member to guide the finishing tool 41 when it is inserted into the provisional hole 13A3 of the bearing work 13A, while the insertion guide portion 41c is formed integrally with the sizing working portion 41b. This insertion guide portion 41c includes a front end guide portion 41c1 provided in the leading end portion of the finishing tool 41 and a tapered portion 41c2 for connecting the front end guide portion 41c1 continuously with the sizing working portion 41b. The front end guide portion 41c1 has a hemispherical-shaped guide surface in the most leading end portion thereof and, on the backward side (in FIG. 1, on the right side) of the guide surface, integrally therewith, there is formed a straight portion having a slightly smaller outside diameter than the outside diameter of the sizing working portion 41b; and, the straight portion extends in the axial direction of the finishing tool 41 while its diameter is constant.

The tapered portion 41c2 is continuously enlarged in the outside diameter dimension from the straight portion of the front end guide portion 41c1 to the sizing working portion 41b and, due to the inclined side face of the tapered portion 41c2, the insertion operation of the finishing tool 41 from the front end guide portion 41c1 to the sizing working portion 41b can be executed smoothly without damaging the bearing work 13A.

When carrying out a finish working step (see FIG. 5E) using the above-structured finishing tool 41, the finishing tool 41 is inserted into the provisional hole 13A3 of the bearing work 13A. In this case, firstly, the hemispherical-shaped surface of the front end guide portion 41c1 of the insertion guide portion 41c formed on the leading end side of the finishing tool 41 is smoothly inserted into the provisional hole 13A3 of the bearing work 13A while it is being guided, which can eliminates a probability that the bearing work 13A can be damaged by the finishing tool 41.

Further, the straight portion of the front end guide portion 41c1 is then inserted into the provisional hole 13A3 with a given clearance between them and, as the insertion of the front end guide portion 41c1 advances, the angle and parallelism of the axis of the sizing working portion 41b (pressure contact working portion) on the rear side of the finishing tool 41 can be gradually aligned with the axis (Z axis) of the bearing work 13A through the floating holder mechanism 42.

And, at the time when the tapered portion 41c2 is completely inserted into the provisional hole (bearing hole) 13A3, the angle and parallelism of the axis of the sizing working portion 41b (pressure contact working portion) on the rear side of the finishing tool 41 are completely aligned with the axis (Z axis) of the bearing work 13A. At the then time, the portions of the finishing tool 41, which extends from the front end guide portion 41c1 to be initially inserted into the provisional hole (bearing hole) 13A3 over to the sizing working portion 41b, are continuously connected together by the tapered portion 41c2; and, therefore, the guiding operation for alignment of the sizing working portion 41b can be executed smoothly without causing any damage in the bearing work 13A.

Thus, the working of the provisional hole 13A3 of the bearing work 13A by the sizing working portion 41b is started in a state that the axis of the sizing working portion 41b is aligned with the axis of the provisional hole 13A3 with high precision. After then, due to the pressure-contact plastic deformation of the provisional hole 13A3 by the sizing working 41b, the inner peripheral surface of the provisional hole 13A3 of the bearing work 13A can be finish worked with high precision without leaving any cutting traces or wavy traces that could occur in the conventional cutting operation. That is, as in the present embodiment, in case where the pressure contact working portion is composed of a sizing working tool, the finish working of the inner peripheral surface of the bearing can be carried out with very high precision.

The finish working precision can be confirmed, for example, from the results shown in FIG. 15. The results shown in FIG. 15 are obtained in the following manner: that is, the axis of the finishing tool 41 serving as a sizing working tool is intentionally deviated from the axis of the bearing work 13A and, in correspondence to the axis deviation amounts thereof (in FIG. 15, vertical axis), the roundness and surface roughness (in FIG. 15, horizontal axis) of the finish worked bearing work 13A are actually measured. From these actual measurement results, it has been confirmed that the finishing precision varies little regardless of the axis deviation amounts.

Especially, in the case of the bearing member 13 for a dynamic pressure bearing in which the finished inner peripheral surface thereof requires high precision, by forming the finishing tool 41 of a sizing working tool, the bearing inner peripheral surface having high-precision diameter tolerance, surface roughness and roundness can be obtained at a low cost and, therefore, a good bearing characteristic can be obtained easily.

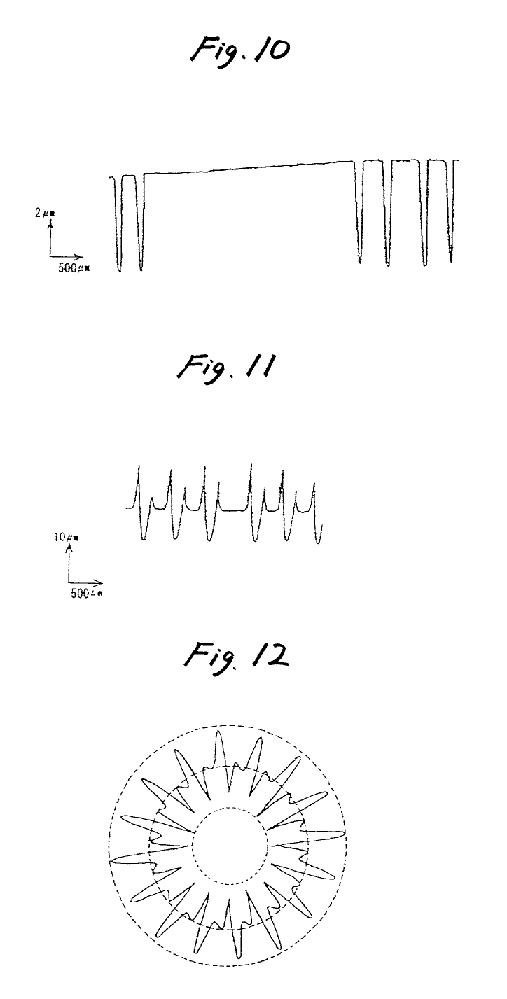

For example, it has been confirmed that a surface showing such an uneven state as shown in FIG. 9 after execution of the groove working step shown in FIGS. 5C and 5D has turned out into such a very smooth mirror surface state as shown in FIG. 10 after a finish working step is carried out on the surface according to the finish working step using the sizing working tool 41 shown in FIG. 5E.

In this case, the finish working step shown in FIG. 5E can also be executed by an inexpensive device which is different from a device for executing the cut working (lathing) step shown in FIGS. 5A-5C. Also, the radial dynamic pressure generating groove 13b working step shown in FIG. 5C can also be executed using a different device.

And, in case where the finish working step of the bearing member 13 for use in a dynamic pressure bearing device is executed by the above-mentioned sizing working, there can be omitted the raised portion removal working step shown in FIG. 5D. That is, in case where, after execution of the radial dynamic pressure generating groove 13b working step shown in FIG. 5C, the raised portion removal working step shown in FIG. 5D is omitted and thus the finish working step shown in FIG. 5E is carried out immediately, the inner peripheral surface of the provisional hole 13A3 of the bearing work 13A can be finished with high precision.

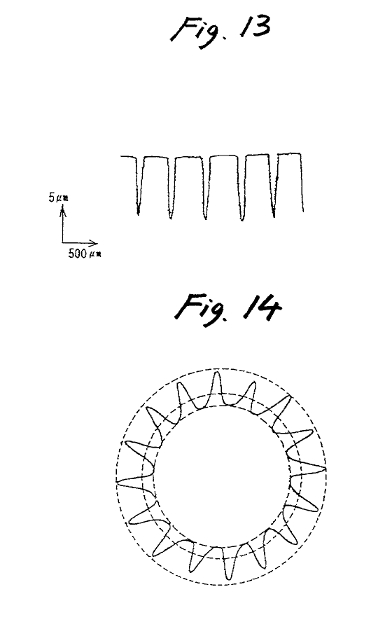

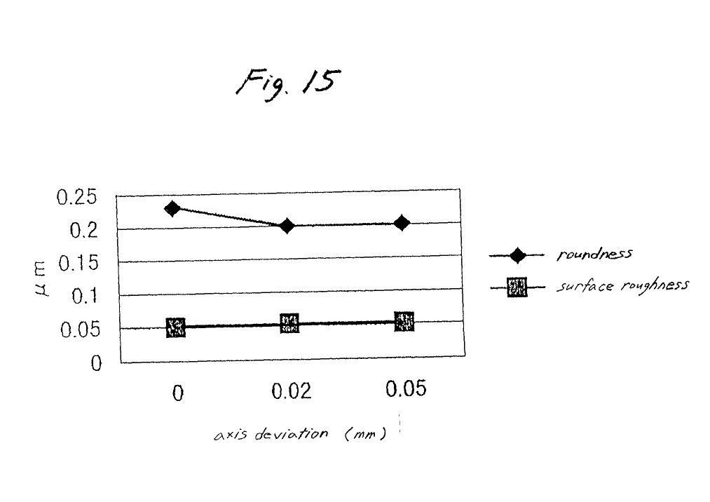

For example, it has been confirmed that a surface showing such an uneven state as shown in FIGS. 11 and 12 after execution of the groove working steps shown in FIG. 5C has turned out into such a very smooth mirror surface state as shown in FIGS. 13 and 14 after a finish working step is carried out on the surface according to the finish working step using the sizing working tool 41 shown in FIG. 5E.

Although description has been given heretofore in concrete of an embodiment of the invention enforced by the present inventors, of course, the invention is not limited to the illustrated embodiment but various changes and modifications are also possible without departing from the subject matter of the invention.

For example, the above-mentioned finish working tool is not limited to an ordinary sizing working tool but, even in case where a pressure contact working is performed using a transfer working tool using a round rod, there can be obtained similar operations and effects to the illustrated embodiment.

Also, the application of the invention is not limited to the hard disk drive (HDD) motor but, for example, the invention can also similarly apply to a dynamic pressure bearing device which is used in a motor for driving or rotating a polygonal mirror. Further, the invention is not limited to the dynamic pressure bearing device but it can also similarly apply to a finish working which is used to finish work an ordinary bearing member such as a slide bearing.

What is claimed is:

1. An apparatus for manufacturing a bearing member formed with a bearing hole, comprising:
a finishing tool, that finishes an inner peripheral surface of the bearing hole, the finishing tool including:
a pressure contact working portion, inserted into the bearing hole to plastically deform the inner peripheral surface by applying a press contact force thereon; and
an insertion guide portion, provided in a front side of the pressure contact working portion with respect to the bearing hole; and
a floating mechanism, that holds the finishing tool movably in a radial direction of the bearing hole and slantably with respect to an axis of the bearing hole.

2. The manufacturing apparatus as set forth in claim 1, further comprising a tool stage, on which the floating mechanism is mounted.

3. The manufacturing apparatus as set forth in claim 1, wherein the insertion guide portion includes:
a front end guide portion provided in a leading end of the finishing tool and having a diameter which is smaller than a diameter of the press contact working portion; and
a tapered portion for continuously connecting the front end guide portion and the press contact working portion.

4. The manufacturing apparatus as set forth in claim 3, wherein a sizing working tool serves as the press contact working portion.

5. The manufacturing apparatus as set forth in claim 4, wherein the sizing working tool is provided with a predetermined lead angle with respect to the axis of the bearing hole.

6. The manufacturing apparatus as set forth in claim 5, further comprising a tool for forming a dynamic pressure groove on the inner peripheral surface of the bearing member.

7. A method of manufacturing a bearing member formed with a bearing hole, comprising the steps of:
providing a finishing tool, which includes a pressure contact working portion, and an insertion guide portion, provided in a front side of the pressure contact working portion with regard to the bearing hole, and which is movable in a radial direction of the bearing hole and slantable with respect to an axis of the bearing hole;
inserting the insertion guide portion into the bearing hole while aligning an axis of the pressure contact working portion with the axis of the bearing hole; and
inserting the pressure contact working portion into the bearing hole while deforming an inner peripheral surface of the bearing hole by applying a press contact force thereon.

8. The manufacturing method as set forth in claim 7, further comprising the step of mounting the finishing tool onto a tool stage through a floating mechanism which realizes the alignment movement of the finishing tool.

9. The manufacturing method as set forth in claim 7, further comprising the step of forming a dynamic pressure groove on the inner peripheral surface of the bearing hole, before inserting the insertion guide portion of the finishing tool.

10. A finishing tool for finishing an inner peripheral surface of a bearing hole formed in a bearing member, comprising:
a pressure contact working portion, inserted into the bearing hole to plastically deform the inner peripheral surface by applying a press contact force thereon;
an insertion guide portion, provided in a front side of the pressure contact working portion with regard to an inserting direction of the finishing tool; and
a floating mechanism, that holds the insertion guide portion and the pressure contact working portion movably in a radial direction of the bearing hole and slantably with respect to an axis of the bearing hole.

11. The finishing tool as set forth in claim 10, wherein the insertion guide portion includes:
a front end guide portion provided in a leading end of the finishing tool and having a diameter which is smaller than a diameter of the press contact working portion, and
a tapered portion for continuously connecting the front end guide portion and the press contact working portion.

12. The finishing tool as set forth in claim 11, wherein a front end of the front end guide portion is rounded.

13. The finishing tool as set forth in claim 10, wherein a sizing working tool serves as the press contact working portion.

14. The finishing tool as set forth in claim 13, wherein the sizing working tool is provided with a predetermined lead angle with respect to the axis of the bearing hole.
